(19) United States
(12) Patent Application Publication
(10) Pub. No.: US 2010/0297307 A1
(43) Pub. Date: Nov. 25, 2010

(54) MICROWAVABLE COOKIE DOUGH AND PACKAGING THEREFOR

(76) Inventors: Urban Nilsson, Aurora, OH (US); Deborah Belser, Chagrin Falls, OH (US)

Correspondence Address: WINSTON & STRAWN LLP;PATENT DEPARTMENT, 1700 K STREET, N.W., WASHINGTON, DC, 20006, US

(21) Appl. No.: 12/812,568

(22) PCT Filed: Jan. 19, 2009
(86) PCT No.: PCT/EP2009/050532

§ 371 Date: Jul. 12, 2010

Related U.S. Application Data
(60) Provisional application No. 61/023,637, filed on Jan. 25, 2008.

(51) Int. Cl. A21D 2/08; B65D 81/34; A21D 2/34; A21D 10/02; A21D 8/06

(52) U.S. Cl. 426/107; 426/549; 426/551; 426/558; 426/234

(57) ABSTRACT

A ready-to-use, microwavable cookie dough formulation that includes a flour mixture of (a) a gluten-containing flour and (b) a low-gluten flour or a starch component in a weight ratio of (a)/(b) of greater than 2:1, sugar, water and a spread-controlling agent. The spread controlling agent includes a cellulose component, a pregelatinized starch, a humectant, and optionally dietary fiber, together in a combined amount effective to impart water retention to the dough formulation but less than about 10% by weight. The agent controls spreading of the dough formulation during microwave baking. The dough formulation is one that is used to make cookies.

### FIELD OF INVENTION

The present invention relates to a cookie dough formulation and the packaging thereof which can be stored chilled or frozen for extended periods of time, and can be baked in a microwave oven.

### BACKGROUND OF THE INVENTION

Microwavable foods have gained enormous popularity in recent years. However, microwaving of bread-based materials can lead to dryness, toughness, and/or a rubber-like texture. With cookies in particular, problems of microwavable baking relate to an inability to control the spreading of the cookies and to achieve a final texture and appearance similar to conventionally (oven-baked) cookies.

Microwavable doughs are known. For instance, WO 00/76321 discloses a process for obtaining leavened dough products that, after frying, have improved freeze/thaw characteristics and can be microwaved. U.S. Pat. No. 4,882,463 is directed to a food vessel for microwavable bread dough. U.S. Pat. No. 5,093,136 discloses a microwavable breakfast cereal prepared from a cookie dough formulation. U.S. Pat. No. 4,911,939 discloses a high-sugar, pre-baked microwavable cookie dough, and EP 0901745 discloses a microwave cake mix with mold.

Regarding pre-made doughs more generally, U.S. 2007/0042099 discloses a ready-to-bake refrigerated batter, U.S. 2002/0142081 discloses a shelf-stable cookie dough product, and U.S. Pat. No. 6,280,783 discloses a shelf-stable cookie dough product, packaging apparatus, and process.

The heating profile in conventional baking is from outside in, where the crust is the hottest part and the center is the coolest. In microwave baking, however, the profile is reversed; the interior of the dough absorbs the microwaves and transfers them into heat, and evaporative cooling results in the exterior being cooler than the interior. As a consequence of the microwave process, moisture is driven from the inside at a much higher rate than in conventional baking. This results in a much different texture than in conventionally baked cookies. The crust lacks crispness and browning and the interior gets hard and dry.

In addition to the different heating profile, the heating during microwave baking is much faster than during conventional baking. This means that the rate of rheological changes and the rate of release and thermal expansion of gases, such as CO₂ from the chemical leavening, and evaporation of water, are both drastically changed. Since the expansion of a baked good is intimately related to the interplay between gas formation/expansion and the rheological changes, any deviations that alters these factors and the interactions between them can be detrimental to the final product structure. The rheological properties of the dough must be such that the formed gas can be captured to a desired extent, the flow of the dough gives a desired width to height ratio, and the “setting” of the structure must occur at a certain moment allowing the structure to support itself as the gas pressure drops. In some cookies, a more collapsed structure is desired and then the setting must be delayed to allow a certain collapse when the baked cookie is cooled down.

A cookie dough suited for baking in a conventional oven does not fulfill the three requirements listed above. Typically, the conventional dough spreads too much, giving a flat dome shaped cookie with thin edges, develops too much gas and is unable to retain much of the gas, leading to crater like pores on the surface, and sets the structure too early, resulting in a cake-like structure.

The present invention addresses the inadequacies of the prior art and provides a microwavable cookie dough that achieves the desired characteristics associated with conventionally baked cookie dough.

### SUMMARY OF THE INVENTION

The invention relates to a ready-to-use, microwavable cookie dough formulation comprising a flour mixture of (a) a gluten-containing flour and (b) a low-gluten flour or a starch component in a weight ratio of (a)/(b) of greater than 2:1, sugar, water and a spread-controlling agent. Advantageously, the spread controlling agent comprises a cellulose component, a pregelatinized starch, and a humectant in a combined amount effective to impart water retention to the dough formulation but less than about 10% by weight so that spreading of the dough formulation during microwave baking is controlled.

The preferred cellulose component is methyl cellulose or hydroxyl methyl cellulose, and is present in an amount of about 0.1% to 1% by weight of the formulation. Also, the pregelatinized starch is typically present in an amount of about 0.1 to 4% by weight of the formulation. The humectant is glucose, or fructose, typically in the form of corn syrup, high fructose corn syrup, or an invert sugar, and is present in an amount of no more than about 5% by weight of the formulation. If desired, the spread-controlling agent can further comprise a fiber component of beet, pea, oat, soy or other food grade fiber, in an amount of no more than about 1% by weight of the formulation.

Typically, the flour mixture is present in the dough formulation at an amount of about 25 to about 35%, the sugar is present in an amount of about 20 to about 30%, and the water is present in an amount of about 5 to about 20%, with each amount based on the weight of the formulation. The sugar may be present as the combination of granulated and powdered sugar in a weight ratio of about 1:1 to about 3:1, while in the flour mixture, the gluten-containing flour is wheat flour, the low-gluten flour is rice flour and the starch is rice starch or corn starch. Preferred weight rations of (a) to (b) are about 5:1 to about 25:1 and more specifically about 10:1 to about 20:1.

The dough formulation may further comprise various ingredients. For example, a pH adjusting agent of baking powder, baking soda, a carbonate or bicarbonate compound may be present in an amount of about 0.1% to 0.5% by weight. Also, one or more of a fat in an amount of about 12 to about 20%, egg, egg white, egg yolk, or an egg substitute in an amount of about 0.1% to about 10%, or an emulsifier in an amount of about 0.1 to about 1%, can be present wherein each amount is based on the weight of the formulation. The emulsifier is typically a glyceride or food grade ester and is preferably present in an amount of about 0.4% to about 0.8%. Also, inclusions of chocolate, nuts, candy, fruit, or cereal in an amount of about 1 to about 30% by weight of the formulation may be present.

Another embodiment of the invention relates to a package comprising the dough formulation disclosed herein and a susceptor material at least partially in contact with the dough and configured to provide optimal heat distribution during microwave baking of the dough formulation. The susceptor material is generally provided in the shape of a tube, disk, box, bowl, or cone and has at least one surface in direct contact with the dough formulation for providing even heating, crisping, or surface browning of the dough formulation to prepare a baked product. In particular, the susceptor material has a surface or cavity which has a shape that corresponds at least partially to that of the baked product in contact therewith and the dough formulation spreads onto, into or throughout the cavity during microwave baking before achieving the final baked product. Preferably, the susceptor is a patterned susceptor to direct heat for proper baking of the dough formulation.

Yet another embodiment of the invention is a method for microwave baking of products such as cookies which comprises associating one of the dough formulations disclosed herein in contact with at least a portion of a susceptor material configured to provide optimal heat distribution during microwave baking of the dough formulation so that when the dough formulation and susceptor material are subjected to microwaves, the dough formulation exhibits controlled spreading onto the susceptor material during microwave baking to achieve a final baked product. Preferably, the susceptor is configured or designed to provide the optimal heat distribution and uniform cooking of the dough when the dough is cooked in a microwave oven, regardless of variation between individual microwave ovens.

In this method, the susceptor material is generally provided with a surface or cavity which has a shape that corresponds at least partially to that of the baked product in contact therewith and the dough formulation spreads onto, into or throughout the cavity during microwave baking before achieving the final baked product. Also, the dough formulation and susceptor material or a package containing those components are subjected to microwaves sufficient to cause controlled spreading of the dough formulation onto, into or throughout the cavity during microwave baking before achieving the final baked product.

A further embodiment relates to the use of the present spread controlling agent in a ready-to-use, microwavable dough formulation of the type disclosed herein so that spreading of the dough formulation during microwave baking is controlled. In all of these embodiments, the preferred dough formulation is that of a cookie dough and the preferred baked product is a cookie. In these formulations, the spread-controlling agent comprises a cellulose component, a pregelatinized starch, and a humectant in a combined amount effective to impart water retention to the dough formulation but less than about 10% by weight.

### DETAILED DESCRIPTION OF THE PREFERRED EMBODIMENTS

The current invention combines several features to achieve the desired product characteristics. For example, the dough is formulated for extended shelf life under refrigerated conditions, desired spread characteristics, optimal gas release, moisture retention and desired final structure during baking. In order to produce a baked product such as a cookie that has these desired qualities of a conventionally baked product or cookie, it is necessary to control the rate that the dough spreads during baking. The dough spread during microwave baking depends partly on the distribution of available water. This can be controlled by the type of sugar used, the specific combination of sugar granulation, and the presence of other components such as cellulose, starch, a low-gluten flour or starch, dietary fibers, and emulsifier.

Acceptable sugars for use with the invention include, but are not limited to, fructose, molasses, sucrose, corn syrup, glucose, lactose, galactose, or mixtures thereof. Preferably, sucrose is used, in the form of granulated sugar. To increase dough sweetness, a sugar substitute such as sorbitol, saccharine or any other known sugar substitute can be added either in conjunction with sugar or as a substitute for the sugar. Advantageously, sucrose helps preserve the dough during refrigeration, i.e., sucrose allows the dough to be somewhat hard, yet spread well during baking to form the desired shape. Other sugar substitutes or artificial, i.e., non-nutritive sweeteners can be used when low calorie baking products are to be made. The sugar, sugar substitute or combination thereof can be present in an amount from about 5% to about 45%, more preferably about 18 to 33%, and most preferably about 25 to 30% by weight of the formulation. In preferred embodiments where a sugar substitute is used, the sugar substitute can constitute up to about 10% of the total amount of sugar, and more preferably, up to about 5%.

Additionally, a humectant can be included in the formulation to contribute to moisture retention and prevent recrystallization of sugars. Suitable humectants include monosaccharides such as glucose, and fructose, and can be present as corn syrup, high fructose corn syrup, invert sugar, and the like. Desirable amounts can be in the range of about 1 to 5% by weight of the formulation; particularly preferred embodiments can have a range of about 1.5 to 2%.

The formulation can contain a total water content of about 5 to 20%, and preferably 10 to 17%. In a preferred embodiment, the total water content of the dough is about 13%, which includes any water that may be added to the formulation, as well as water that is present in various components, such as fat, flour and molasses. In another embodiment, the amount of water that can be added to the formulation is about 4 to about 6% by weight of the total formulation.

Embodiments of the invention can also utilize a combination of granulated and powdered sugars to help achieve the desired amount of moisture retention and spread. A ratio of granular to powdered sugar higher than about 1:1 is preferable, such as in the a range of 1:1 to 10:1, and more preferably about 1.5:1. In a particularly preferred embodiment, the ratio of granular to powdered sugar is about 1.2:1.

Exemplary spread-control agents used in embodiments of the present invention include a cellulose component, such as methylcellulose, hydroxypropylmethycellulose, methylhydroxypropylcellulose, and the like, polymers thereof, and combinations thereof. The cellulose component helps achieve the improved moisture content and spread control when present in a range of 0.1 to 1% of the formulation. In a preferred embodiment, the range is within 0.2 to 0.5%.

Starches also contribute to control of spread and moisture levels in the dough. Preferred embodiments of the invention use a pregelatinized starch. The pregelatinized starch is able to bind water during processing of the dough, thus reducing the spread during baking. In a particularly preferred embodiment, the cookie dough includes a pregelatinized starch, in an amount of up to 2% by weight of the formulation. Acceptable starches include potato, corn, wheat, rice, and the like, which can be present in an amount of less that about 5% by weight of the formulation, more preferably about 2% or less.

Compared to conventional baking, microwave baking often has a higher degree of gelatinization of the starch in the flour, due to local overheating, or “hot spots”. A higher degree of gelatinization is undesirable, as it negatively affects the final cookie texture. Gelatinization can be controlled through the use of flour mixtures or mixtures of flour and ungelatinized starch. Accordingly, certain embodiments of the invention use a combination of a gluten-containing flour and a low gluten flour. Low-gluten flours such as rice, quinoa, amaranth, or spelt flour with low tendency to gelatinize can be used to replace some of the gluten-containing flour, such as wheat. Alternatively, a starch component, such as a rice or corn starch can be used to replace a portion of the gluten-containing flour. This reduces starch gelatinization at possible hot spots during baking. The ratio of gluten-containing flour to low-gluten flour or starch component is about 1:1 to about 30:1, and preferably about 10:1 to about 20:1. In a preferred embodiment, the low-gluten flour or starch component is present in amount of about 5% of the amount of gluten-containing flour, or a ratio of about 20:1. In a particularly preferred embodiment, the dough contains wheat flour and rice flour, in a ratio of about 20:1.

In further embodiments, the cookie dough includes the combination of a low level of pregelatinized starch with a mixture of gluten-containing flour and a low-gluten flour or starch component in the amounts set forth above to achieve improved control of the final gelatinization.

The cookie dough can also include dietary fibers to increase water retention and help achieve the desired the final product texture. The dough can include 0.1 to 5% of an acceptable dietary fiber, such as beet fiber, with particularly preferred embodiments including about 0.1 to 1% and preferably between 0.1 to 0.2% by weight of the formulation. Other food-grade fibers as known in the art, such beet, oat, pea, and soy fiber, can be used.

Another component that helps delay and reduce gelatinization during microwaving is emulsifier. The emulsifier also helps achieve an even distribution of water and fat in the dough, and can be present in an amount of about less than about 5%, more preferably less than about 2% by weight of the formulation. In a particularly preferred embodiment, the emulsifier is present in an amount of about 0.6 to 0.7%. Any suitable emulsifier as known in the art, such as a mono- or diglyceride, DATEM esters of mono- and di-glyceride, and sodium steroyl lactate can be used. In one preferred embodiment, the emulsifier is COBA 2240, in an amount of about 0.65%.

The composition can also include a water-binding such as MIRAGEL™, that can help thicken and stabilize the composition. Other known agents that are capable of binding water, such as gums, starches and gelatins can also be used.

Embodiments of the present invention can also use a pH adjusting agent. Microwave baking, unlike convention baking, does not require significant gas development from a leavening agent. However, certain agents typically used as leavening agents can also regulate the pH of the dough and have an effect on taste. Accordingly, the embodiments of the present invention can use a pH adjusting agent, more traditionally thought of as a leavening agent, to serve as a pH regulator and taste component. The pH adjusting agent may also contribute to controlling the spread of the dough as it bakes. Preferred embodiments of the invention include a pH adjusting agent, such as sodium bicarbonate, in amount of less than 3%, more preferably less than 1%, and most preferably less than 0.5% by weight of the formulation. In a particularly preferred embodiment, the dough includes about 0.2% of the pH adjusting agent. Other acceptable pH adjusting agents include baking soda, a carbonate or bicarbonate compound, and phosphates such as disodium dihydrogen pyrophosphate.

Fat also contributes to the moisture content of the dough. The fat used in the dough composition according to embodiments of the invention can be a solid or liquid fat at room temperature. The fat can be of animal or plant origin, such as, lard, tallow, butter oil, butter, margarine, shortening, corn oil, copra oil, palm oil, sunflower oil, safflower oil, canola oil, soya bean oil, coconut oil, palm kernel oil, cotton oil, peanut oil, olive oil, or mixtures thereof. In preferred embodiments of the invention, the fat is butter. The amount of fat in the dough ranges from about 10 to 25% by weight of the formulation, more preferably about 15 to 18%.

Another dough component is egg product, in the form of a whole egg, egg white, egg yolk, or egg substitute. Preferably, the egg product is a whole egg in solid form, in an amount of about 1 to 10% by weight of the composition, more preferably about 2 to 3.5%.

The dough can also include natural or artificial flavoring agents, including but not limited to, vanilla, butter, cinnamon, ginger, cocoa powder, fruit flavor, nut flavor (e.g. nut butters or extracts), and the like. These are typically used in an amount of about to 0.01% to about 8% by weight, and preferably from 0.25 to 7% by weight. Of course, various combinations of these flavoring agents are possible, as desired.

The dough can further include morsel additions, such as chocolate pieces, oat flake pieces, raisins, fruit pieces, whole nuts or nut pieces, i.e., groundnuts, hazelnuts or other nuts, caramel, or various mixtures thereof. The morsel additions can be of any edible size, and are typically from about 1 mm to about 25 mm, preferably from about 4 mm to about 10 mm. The amount is not critical and can vary from about 1 to about 30%, preferably about 15 to 25% by weight. Particularly preferred embodiments can have a range of about 20 to 23%. The chocolate can be, dark chocolate, milk chocolate, white chocolate, compound coatings or mixtures thereof in the form of pellets or chunks. The chocolate can be a commercial chocolate or a chocolate of the type used in pastry making or in catering.

The quality of the baked cookie that results from the dough set forth herein is further improved by the use of active packaging, which is also a component in preferred embodiments of the present invention. The packaging includes a susceptor component to generate uniform heating and spreading of the dough, as well as browning and crisping at the surface of the cookie. The susceptor is an active microwave energy heating element in the form of a laminate including a substrate formed of suitable material such as paper, paperboard or a polymeric film, with a microwave energy interactive material on one surface of the substrate. The energy interactive material can be a metallized film, such as a thin film of aluminum.

In embodiments of the invention, the susceptor moderates penetration of microwave energy in the peripheral region of the food product and directs microwave energy towards its central region. This is achieved by a patterned design, which allows the newly formed dough portion, created as the dough bakes and spread, to be exposed to a greater percentage of the microwave energy. The result is more even baking, browning, and crisping.

The susceptor pattern can include areas of reduced heat, achieved by portions where the metal layer heat has reduced conductivity. This reduced-heat portion of the metal layer can be achieved by making the layer thinner, having no metal present, or otherwise inactivating the metal. Additionally, different types of metals can be used in different portions, depending on the desired amount of intensity in regions of the susceptor. For example, since dough tends to spread outwardly from the center, the metal layer at the periphery of the susceptor can have a greater conductivity or intensity, where the metal layer at the center of the susceptor can have a reduced intensity, for example by being thinned or removed. Alternatively, the areas of reduced heat can be interspersed throughout the susceptor, such as a radial spray pattern, or a checkerboard pattern. The size of the susceptor can also be larger than the size of the unbaked dough, in order to accommodate the dough as it spreads.

The susceptor achieves the desired product (e.g. a microwave-baked cookie that has the qualities of an oven-baked cookie) by minimizing the impact of variability across microwaves. For example, microwaves can vary significantly based on factors such as brand, size, wattage, age, and the like. The patterned susceptors set forth in embodiments of the present invention minimize these variations to achieve optimal cooking and an optimal cookie, regardless of these varying factors. The susceptor is thus designed or patterned to provide the appropriate heat distribution. Such patterning is generally known in the art and routine tests can be conducted to provide or obtain the most desirable patterning arrangements for any particular dough formulation.

In one embodiment of the invention, the formulation can be a dual-texture, including an edible outer shell structure, taking the form of a wafer, cake, or biscuit-style dough, and presented in the shape of, for example, an ice cream cone. The formulation of the outer shell can also be a slight formula modification from the cookie dough that is inside the shell, with the result that, upon microwave baking, the outer shell (e.g. the cone) surprisingly is crisp, while the interior is soft and chewy.

Packaging is available in several shapes, with the susceptor corresponding to the shape of the dough and provided as, for example, a flat disc, accordion or other folded or pleated shapes, a pouch or sleeve, a cylinder or tube, a box (with the susceptor lining the top and bottom), or a bowl. In one embodiment, the packaging can include a susceptor tray with a plastic top film to retain moisture (in the form of steam).

Depending on the packaging design, there can be greater or less contact with the surface of the cookie. For example, susceptor in the shape of a sleeve or cylinder allows for more extensive contact, while others such as a flat disk, maintain contact with only a portion of the cookie surface.

Additionally, the susceptor can be designed or patterned to provide an evenly browned cookie, with the appearance that the cookie was baked on a cookie sheet in the oven.

The dough of the invention is formulated to last up to at least about 10 weeks under refrigeration conditions, and up to at least about 1 year under freezer condition. The dough can also include glycerol if desired to provide stability during storage. Other components such as antioxidants or preservatives can be added to contribute to the extended shelf as is known in the art.

### EXAMPLES

The invention is further defined by reference to the following illustrative, non-limiting examples.

### Example 1

Formula 1: Chocolate Chip Cookie Recipe for conventional oven
2¼ cups all-purpose flour
1 teaspoon baking soda
1 teaspoon salt
1 cup (2 sticks, 1/2 pound) butter, softened
¾ cup granulated [white] sugar
¾ cup packed brown sugar
1 teaspoon vanilla extract
2 eggs
2 cups (12-ounce package) Semi-Sweet Chocolate Morsels

### Dough Mixing

Combine flour, baking soda and salt in small bowl. Beat butter, granulated sugar, brown sugar and vanilla in large mixer bowl. Add eggs one at a time, beating well after each addition; gradually beat in flour mixture. Stir in morsels. Drop by rounded tablespoon onto ungreased baking sheets.

### Baking

Conventional oven: bake in preheated 375° F. oven for 9 to 11 minutes or until golden brown. Let stand for 2 minutes; remove to wire racks to cool completely. The resulting cookies are crispy on the exterior and have a soft and chewy interior.
When baked in microwave as 40 g pieces in a 1100 W for 35 sec the dough pieces spread extensively and develops crater like holes and becomes very thin and hard.

### Example 2

Formula 2: Chocolate Chip Cookie Recipe 1 for microwave oven

| | | |
|---|---|---|
| wheat flour | 309.0 | 33.87% |
| margarine | 209.8 | 23.00% |
| sugar white fine granular | 143.4 | 15.71% |
| sugar, powdered | 119.9 | 13.14% |
| corn syrup solids | 19.2 | 2.10% |
| methyl cellulose | 6.0 | 0.66% |
| egg whole solids | 29.9 | 3.28% |
| water | 52.2 | 5.72% |
| Molasses | 16.0 | 1.76% |
| salt | 4.1 | 0.45% |
| sodium bicarbonate | 2.0 | 0.22% |
| vanilla flavor | 0.7 | 0.08% |
| Total (grams) | 912.3 | 100.00% |
| cookie dough | 912.3 | 76.02% |
| chocolate chips | 287.7 | 23.98% |
| | 1200.0 | 100.00% |

### Dough Mixing

Mix margarine with sugars, corn syrup solids, whole egg solids, salt and methyl cellulose into a homogenous mix
Make a slurry of water, molasses, sodium bicarbonate and flavor and mix with the margarine and sugar blend until well mixed.
Add flour and mix until well mixed.
Add chocolate morsels and mix shorly to distribute the morsels evenly.

### Baking

When baked in microwave as 40 g pieces in a 1100 W for 35 sec on susceptor discs the spread of the dough pieces is reduced but still higher than conventionally baked cookies of formula 1. The texture is softer but hardens upon cooling.

### Example 3

Formula 2: Chocolate Chip Cookie Recipe 2 for microwave oven

| | | |
|---|---|---|
| wheat flour | 282.6 | 30.93% |
| Butter | 207.3 | 22.69% |
| sugar white fine granular | 140.9 | 15.42% |
| sugar, powdered | 117.8 | 12.89% |
| corn syrup solids | 19.2 | 2.10% |
| methyl cellulose | 6.0 | 0.66% |
| rice flour | 15.2 | 1.67% |
| beet fiber | 1.6 | 0.17% |
| water binding agent | 11.7 | 1.28% |
| egg whole solids | 29.9 | 3.27% |
| emulsifier | 7.7 | 0.84% |
| water | 51.1 | 5.59% |
| Molasses | 16.0 | 1.75% |
| salt | 4.1 | 0.45% |
| sodium bicarbonate | 2.0 | 0.22% |
| vanilla flavor | 0.7 | 0.07% |
| Total (gram) | 913.7 | 100.00% |
| cookie dough | 913.7 | 76.14% |
| Choc Chips | 286.4 | 23.86% |
| Total | 1200.0 | 100.00% |

### Dough Mixing

Mix margarine with emulsifier, sugars, corn syrup solids, whole egg solids, salt and methyl cellulose into a homogenous mix
Make a slurry of water, molasses, sodium bicarbonate and flavor and mix with the margarine and sugar blend until well mixed.
Add flour, beet fiber and rice flour and mix until well mixed.
Add chocolate morsels and mix thoroughly to distribute the morsels evenly.

### Baking

When baked in microwave as 40 g pieces in a 1100 W for 35 sec on susceptor discs the spread of the dough pieces is similar to conventionally baked cookies of formula 1. The texture is soft in the upper part and crispy in the bottom. The texture retains its softness even after cooling.

It will be appreciated by one of skill in the art that various modifications and variations of the exemplary embodiments disclosed above may be made without departing from the scope of the invention as defined above and with reference to the appended claims.

1. A ready-to-use, microwavable dough formulation comprising a flour mixture of (a) a gluten-containing flour and (b) a low-gluten flour or a starch component in a weight ratio of (a)/(b) of greater than 2:1, sugar, water and a spread-controlling agent comprising a cellulose component, a pregelatinized starch, and a humectant in a combined amount effective to impart water retention to the dough formulation but less than about 10% by weight so that spreading of the dough formulation during microwave baking is controlled.

2. The dough formulation of claim 1 wherein the cellulose component is methyl cellulose or hydroxyl methyl cellulose, and is present in an amount of about 0.1% to 1% by weight of the formulation.

3. The dough formulation of claim 1 wherein the pregelatinized starch is present in an amount of about 0.1 to 4% by weight of the formulation.

4. The dough formulation of claim 1 wherein the humectant is glucose or fructose and is present in an amount of no more than about 5% by weight of the formulation.

5. The dough formulation of claim 4 wherein the humectant is corn syrup, high fructose corn syrup, or an invert sugar.

6. The dough formulation of claim 1 wherein the spread-controlling agent further comprises a fiber component of beet, pea, oat, soy or other food grade fiber, in an amount of no more than about 1% by weight of the formulation.

7. The dough formulation of claim 1 wherein the flour mixture is present in an amount of about 25 to about 30%, the sugar is present in an amount of about 20 to about 30%, and the water is present in an amount of about 5 to about 20%, with each amount based on the weight of the formulation.

8. The dough formulation of claim 7, wherein the sugar is present as the combination of granulated and powdered sugar in a weight ratio of about 1:10 to about 3:1.

9. The dough formulation of claim 7 wherein the flour mixture of the gluten-containing flour to the low-gluten flour or starch is in a weight ratio of about 5:1 to about 25:1.

10. The dough formulation of claim 7 wherein the gluten-containing flour is wheat flour, the low-gluten flour is rice flour and the starch is rice starch or corn starch, and the weight ratio is about 10:1 to about 20:1.

11. The dough formulation of claim 1, further comprising a pH adjusting agent of baking powder, baking soda, a carbonate or bicarbonate compound present in an amount of about 0.1% to 0.5% by weight.

12. The dough formulation of claim 1, further comprising one or more of a fat in an amount of about 12 to about 20%, egg, egg white, egg yolk, or an egg substitute in an amount of about 0.1% to about 10%, or an emulsifier in an amount of about 0.1 to about 1%, with each amount based on the weight of the formulation.

13. The dough formulation of claim 12 wherein the emulsifier is a glyceride or food grade ester and is present in an amount of about 0.4% to about 0.8%.

14. The dough formulation of claim 1, further comprising inclusions of chocolate, nuts, candy, fruit, or cereal in an amount of about 1 to about 30% by weight of the formulation.

15. A package comprising the dough formulation of claim 1 and a susceptor material at least partially in contact with the dough and configured to provide optimal heat distribution during microwave baking of the dough formulation.

16. The package of claim 15 wherein the susceptor material is provided in the shape of a tube, disk, box, bowl, or cone and has at least one surface in direct contact with the dough formulation for providing even heating, crisping, or surface browning of the dough formulation to prepare a baked product.

17. The package of claim 16 wherein the susceptor material has a surface or cavity which has a shape that corresponds at least partially to that of the baked product in contact therewith and the dough formulation spreads onto, into or throughout the cavity during microwave baking before achieving the final baked product.

18. The package of claim 15 wherein the susceptor is a patterned susceptor to direct heat for proper baking of the dough formulation.

19. A method of microwave baking which comprises associating the dough formulation of claim 1 in contact with at least a portion of a susceptor material configured to provide optimal heat distribution during microwave baking of the dough formulation so that when the dough formulation and susceptor material are subjected to microwaves, the dough formulation exhibits controlled spreading onto the susceptor material during microwave baking to achieve a final baked product.

20. The method of claim 19, which further comprises configuring or designing the susceptor with a pattern to provide optimal heat distribution and uniform cooking of the dough when the dough is cooked in a microwave oven, regardless of variation between individual microwave ovens.

21. The method of claim 19 which further comprises providing the susceptor material with a surface or cavity which has a shape that corresponds at least partially to that of the baked product in contact therewith and the dough formulation spreads onto, into or throughout the cavity during microwave baking before achieving the final baked product.

22. The method of claim 19 which further comprises subjecting the dough formulation and susceptor material to microwaves sufficient to cause controlled spreading of the dough formulation onto, into or throughout the cavity during microwave baking before achieving the final baked product.

23. A method of microwave baking which comprises providing the package of claim 15 and subjecting the dough formulation and susceptor material to microwaves sufficient to cause controlled spreading of the dough formulation onto, into or throughout the cavity during microwave baking before achieving the final baked product.

24. (canceled)

25. (canceled)

26. A ready-to-use, microwavable dough formulation comprising a flour mixture of (a) a gluten-containing flour and (b) a low-gluten flour or a starch component in a weight ratio of (a)/(b) of greater than 2:1, sugar, water and a spread controlling agent comprising a cellulose component, characterized in that the spread-controlling agent comprises a cellulose component, a pregelatinized starch, and a humectant in a combined amount effective to impart water retention to the dough formulation but less than about 10% by weight so that spreading of the dough formulation during microwave baking is controlled.
